(19) United States
(12) Patent Application Publication
(10) Pub. No.: US 2011/0032719 A1
(43) Pub. Date: Feb. 10, 2011

(54) CONTROL DEVICE FOR CONTROLLING THE POSITION OF A BUMPER FASCIA

(75) Inventors: Christopher M. Kors, Ann Arbor, MI (US); Jason Stadtherr, Novi, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Ann Arbor, MI (US)

(21) Appl. No.: 12/536,043

(22) Filed: Aug. 5, 2009

(51) Int. Cl. B60Q 1/28

(52) U.S. Cl. 362/505; 362/538

(57) ABSTRACT

A headlamp assembly for an automotive vehicle having a bumper fascia which restrains the movement of the bumper fascia is provided. The bumper fascia includes an exterior surface and an opposite interior surface which faces the engine compartment of the automotive vehicle. The headlamp assembly includes a headlamp housing for receiving a lamp unit. A lens is attached to the headlamp housing to cover a portion of the front end so as to protect the lamp unit. A protrusion extending from a bottom side of the headlamp housing engages with a notch formed on the interior surface of the bumper to control the position of the bumper fascia relative to the headlamp housing.

### FIELD OF THE INVENTION

The present invention is generally related to a bumper of an automotive vehicle, and in particular, to a front bumper having a headlamp assembly which controls the position of the bumper.

### BACKGROUND OF THE INVENTION

Most automotive vehicles have bumper fascias, positioned at the front and the rear of the vehicle, and headlamp assemblies to illuminate or signal actions of the vehicle. A portion of the bumper fascia located adjacent the headlamp assembly is formed having a complementary shape with the headlamp assembly so as to provide an aesthetically pleasing outer appearance of the automotive vehicle. As such, the bumper fascia must be accurately positioned relative to the headlamp assembly.

In most automotive vehicles, the headlamp assembly is attached to a main body of the automotive vehicle, while the ends of the bumper fascia are attached to the side fenders or side panels. However, the connection of the bumper fascia to the side fender or side panels can be insufficient in controlling the side-to-side or lateral movement of the bumper fascia. Therefore, an additional connection is required so that accurate position of the bumper fascia relative to the headlamp assembly is maintained.

It is known in the art to provide automotive vehicle with a control feature to restrain the lateral movement of the bumper fascia The control feature is often placed on the inboard side of the headlamp assembly and simultaneously acts as a bracket for the attachment of the headlamp assembly to the automotive vehicle. Further, other automotive vehicles utilize a control feature which extends from the headlamp lens to the bumper fascia to control the position of the bumper fascia.

However, there are several disadvantages relating to the control feature described above. The space on the inboard side of headlamp assembly is limited and may not provide adequate space to include the control feature. In addition, placing the control feature on the lens of the headlamp assembly increases the occurrence of damage to the lens, as the lens is susceptible to cracking when an external load is placed on the bumper fascia.

Thus, there exists a need for an improved headlamp assembly which is capable of controlling the position of a bumper fascia,

### SUMMARY OF THE INVENTION

The present invention provides an improved headlamp assembly which overcomes the above-mentioned disadvantages of the previously known means of controlling the position of a bumper fascia.

In brief a control device for restraining the lateral, or side-to-side, movement of a bumper fascia relative to a headlamp assembly, is provided. The control device includes a headlamp assembly attached to a main body of the automotive vehicle and a bumper fascia covering a portion of the headlamp assembly. The bumper fascia has an exterior surface and an interior surface having a flange extending towards the vehicle. A pair of walls extends from the flange to define a notch. The headlamp assembly includes a headlamp housing for receiving a lamp unit and a lens for covering the front end. A protrusion extending from a bottom side of the headlamp housing engages with the notch formed on the flange to restrain the lateral movement of the bumper fascia.

The protrusion is optionally formed of a generally planar section which is attached to the bottom side of the headlamp housing by a pair of side walls extending from the top of the generally planar section to the bottom of the headlamp housing. The generally planar section is tapered so as to facilitate the insertion of the protrusion into the notch of the bumper fascia.

### BRIEF DESCRIPTION OF THE DRAWINGS

A better understanding of the present invention will be had upon reference to the following detailed description when read in conjunction with the accompanying drawings, wherein like reference characters refer to like parts throughout the several views and in which:

FIG. 1 is a top side view illustrating a bumper fascia of an automotive vehicle;

FIG. 2 is an enlarged view of section 2 of FIG. 1, which illustrates a notch formed on a flange extending from an interior surface of the bumper fascia;

FIG. 3 is a front elevational view illustrating the headlamp assembly;

FIG. 4 is an enlarged of section 4 of FIG. 3, which illustrates the protrusion;

FIG. 5 is a horizontal cross sectional view illustrating the engagement of the protrusion with the notch;

FIG. 6 is a side view illustrating the headlamp assembly;

FIG. 7 is an enlarged view of section 7 of FIG. 6, which illustrates the protrusion;

FIG. 8 is a side perspective view illustrating the engagement of the protrusion with the notch; and

FIG. 9 is a partial bottom view of the protrusion of the headlamp assembly.

### DETAILED DESCRIPTION OF A PREFERRED EMBODIMENT OF THE PRESENT INVENTION

The present invention has utility as a control device which restrains the movement of a bumper fascia in the lateral, or side-to-side, direction. The control device includes a headlamp assembly attached to main body of the automotive vehicle, and a bumper fascia which covers a portion of the headlamp assembly. The headlamp assembly includes a headlamp housing, a headlamp unit, a position control feature located on the headlamp housing, and a lens covering the front end of the headlamp housing.

After installation of the headlamp housing to the main body of the automotive vehicle, the bumper fascia is placed onto the automotive vehicle and the ends of the bumper fascia are mounted to the side panels or fenders to secure the bumper fascia to the automotive vehicle. The position control feature extends from the bottom side of the headlamp housing to engage with the bumper fascia in order to restrain the lateral movement of the bumper fascia thereby providing the accurate positioning of the bumper fascia relative to the headlamp assembly.

Providing the position control feature on the headlamp housing rather than the lens decreases the occurrence of damage to the lens when an external load is applied to the bumper. In addition, the placement of the position control feature on the bottom side of the headlamp housing takes advantage of the limited amount of design space associated around the headlamp assembly.

It will be appreciated that although the illustrated embodiment of the present invention depicts the bumper fascia 10 as a front bumper, the invention is not limited to such an embodiment. Further, it is also to be understood that in the discussion that follows there is an identical, mirror image headlamp assembly and notch; however, for the sake of clarity only one side will be discussed.

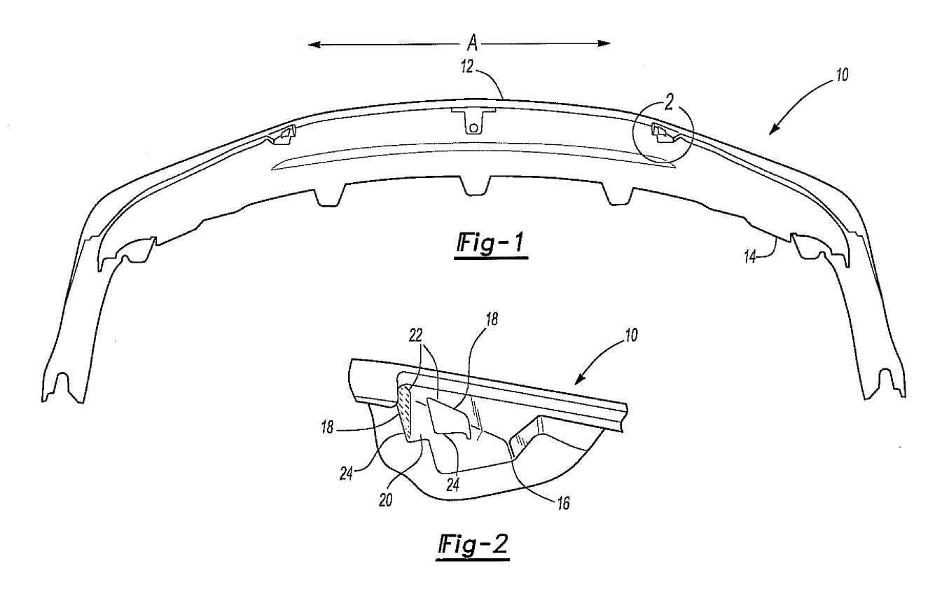

With reference to FIG. 1, a bumper fascia for an automotive vehicle is generally illustrated at 10. The bumper fascia 10 extends along the lateral direction or width of the automotive vehicle in the direction of arrow A. The bumper fascia 10 includes an exterior surface 12 and an opposite interior surface 14 which faces the automotive vehicle.

A flange 16 extends from the interior surface 14 of the bumper fascia 10 in a direction generally traverse to the width of the automotive vehicle. A pair of walls 18 extends outwardly from the flange 16 so as to define a notch 20. The pair of walls 18 extends from a proximate end 22, adjacent the interior surface 14 of the bumper fascia 10, to a distal end 24 located across at least a portion of the flange 16.

Optionally, the pair of walls 18 have a complementary angled orientation such that the distance between the distal ends 24 of the pair of walls 18 is greater than the distance between the proximate ends 22. Tapering the notch 20 so as to have a wider open end facilitates the insertion of the position control feature, which will be described in greater detail below.

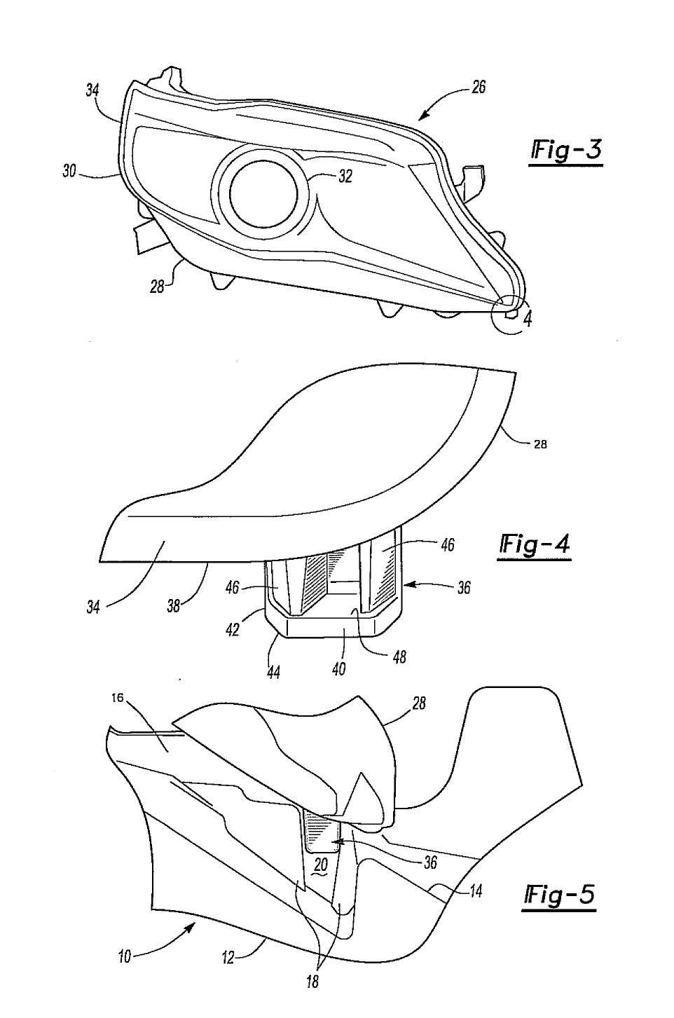

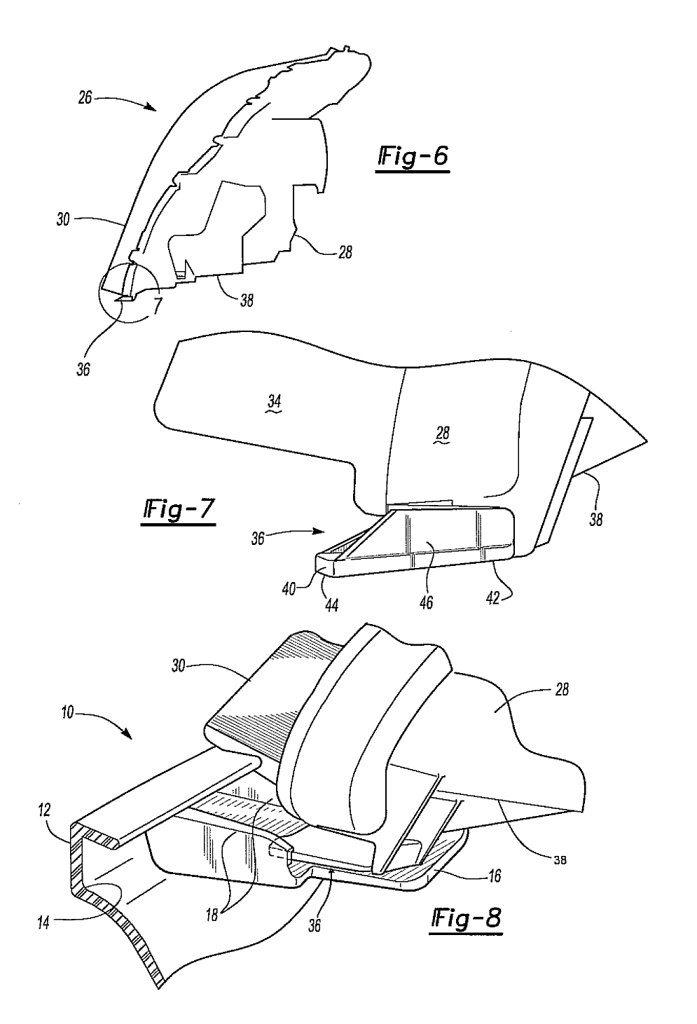

With reference to FIG. 3, a headlamp assembly for a motor vehicle is generally illustrated at 26. The headlamp assembly 26 includes a headlamp housing 28 having a front end 30 for receiving a headlamp unit 32. In the alternative, the headlamp unit 32 can be inserted into a rear end of the headlamp housing 28. The headlamp unit 32 includes a light source and a reflector which are inserted into the front end 30 of the headlamp housing 28. A lens 34 attaches to the headlamp housing 28 to cover a portion of the front end 30 to protect the headlamp unit 32 and to provide an aesthetically pleasing outer appearance of the automotive vehicle.

The headlamp housing 28 includes a position control feature formed as a protrusion 36 to restrain movement of the bumper fascia 10 across the width of the automotive vehicle in the direction of arrow A. With reference to FIGS. 4, 7 and 9, the protrusion 36 extends from a bottom side 38 of the headlamp housing 28 to take advantage of the available space below the headlamp housing 28. It is understood that even though the protrusion 36 and flange 16 are depicted as being located adjacent to the inboard end of the longitudinal length of the headlamp housing 28, the location of the protrusion 36 and the flange 16 are not limited to such a location.

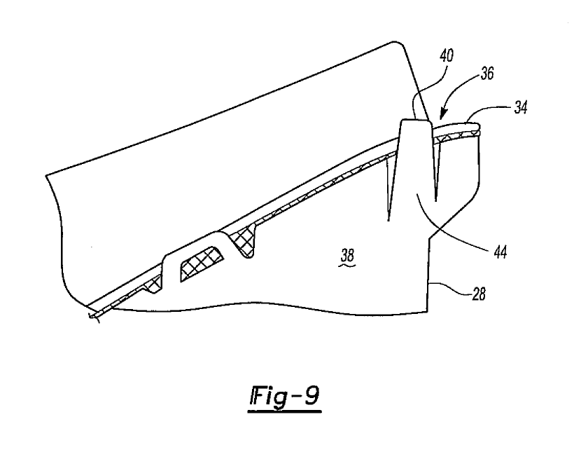

The protrusion 36 includes a generally planar section 40 having a proximal end 42 and a distal end 44. The protrusion 36 is tapered such that the proximal end 42 is wider than the distal end 44 so as to facilitate engagement with the notch 20. The planar section 40 is attached to the bottom side 38 of the headlamp housing 28 by a pair of side walls 46 which extend from a top side 48 of the planar section 40 to the bottom side 38 of the headlamp housing 28. As best seen in FIGS. 7 and 9, the protrusion 36 extends beyond the headlamp housing 28 and beyond a portion of the lens 34 so as to engage with the notch 20.

With reference to FIGS. 5 and 8, the engagement of the protrusion 36 and the notch 20 will now be discussed. During assembly, the headlamp assembly 26 will be attached to the main body of the automotive vehicle prior to the installation of the bumper fascia 10. Once the headlamp assembly 26 is installed, the bumper fascia 10 will be installed onto the automotive vehicle such that the open end of the notch 20 is brought into engagement with the protrusion 36. As the protrusion 36, which extends in a direction generally traverse to the width of the automotive vehicle, is flanked on either side by the pair of walls 18 the movement of the bumper fascia 10 in the direction of the width of the automotive vehicle is restrained, thereby accurately maintaining the position of the bumper fascia 10 relative to the headlamp assembly 26.

In an alternative embodiment, the notch 20 includes a top wall which extends between the pair of walls 18 to partially enclose the notch 20. The assembly of the headlamp assembly 26 and the bumper fascia 10 is the same as described above. By providing the notch 20 with a top wall, the protrusion 36 is capable of controlling the lateral and vertical movement of the bumper fascia 10.

From the foregoing it can be seen that the present invention provides a control device which restrains the lateral, or side-to-side, movement of the bumper. Having described the invention, however, many modifications thereto will become apparent to those of ordinary skill in the art to which it pertains without the deviation of the spirit of the invention defined by the scope of the appended claims.

It is claimed:

1. A headlamp assembly for an automotive vehicle having a bumper fascia extending along the width of the automotive vehicle, the bumper fascia includes an exterior surface and an interior surface having a notch formed therein, said headlamp assembly comprising:
a headlamp housing capable of receiving a lamp unit;
a lens covering a portion of said housing; and
a protrusion extending from a bottom side of said headlamp housing in a direction generally traverse to the width of the automotive vehicle to engage the notch and restrain movement of the bumper fascia in a direction generally parallel to the width of the vehicle.

2. The headlamp assembly of claim 1, wherein said protrusion extends beyond said headlamp housing and beyond a portion of said lens.

3. The headlamp assembly of claim 2, wherein said protrusion is located adjacent to one end of a longitudinal length of said headlamp housing.

4. The headlamp assembly of claim 1, wherein said protrusion is tapered so as to facilitate insertion of said protrusion into the notch.

5. The headlamp assembly of claim 1, wherein said protrusion includes a generally planar section and a pair of side walls extending between said generally planar section and said bottom side of said headlamp housing.

6. The headlamp assembly of claim 1, wherein said lamp unit is received by a front end of said headlamp housing.

7. A control device comprising:
a bumper fascia having an exterior surface and an interior surface;
a notch formed on said interior surface of said bumper fascia; and
a headlamp housing capable for receiving a lamp unit, a portion of said headlamp housing being covered by a lens; and
a protrusion extending in a first direction from a bottom side of said headlamp housing to engage said notch to restrain movement of said bumper fascia in a direction generally traverse to said first direction.

8. The control device of claim 7, wherein said notch is formed on a flange which extends from said interior surface.

9. The control device of claim 8, wherein said notch is formed of a pair of walls extending from said flange.

10. The control device of claim 7, wherein said protrusion extends beyond said headlamp housing and beyond a portion of said lens.

11. The control device of claim 7, wherein said protrusion is located adjacent to one end of a longitudinal length of said headlamp housing.

12. The control device of claim 7, wherein said protrusion is tapered so as to facilitate insertion of said protrusion into said notch.

13. The control device of claim 7, wherein said protrusion includes a generally planar section and a pair of side walls extending between said generally planar section and said headlamp housing.

14. The control device of claim 7, wherein each of said pair of walls extends from said interior surface of said bumper fascia across a portion of said flange.

15. The control device of claim 7, wherein said pair of walls are angled so as to facilitate insertion of said protrusion into said notch.
